(19) United States
(12) Patent Application Publication
(10) Pub. No.: US 2014/0050635 A1
(43) Pub. Date: Feb. 20, 2014

(54) AUTOMATIC DEVICE FOR THE SYNTHESIS OF PEPTIDE-BASED RADIOACTIVE DRUGS FOR DIAGNOSTIC AND/OR THERAPEUTIC USE

(71) Applicants: Carlo Azzi, Napoli (IT); Claudia Castellano, Napoli (IT); Francesca Aversano, Mugnano di Napoli (IT)

(72) Inventors: Carlo Azzi, Napoli (IT); Claudia Castellano, Napoli (IT); Francesca Aversano, Mugnano di Napoli (IT)

(21) Appl. No.: 14/113,843

(22) PCT Filed: Apr. 27, 2012
(86) PCT No.: PCT/IT2012/000127

§ 371 Date: Oct. 25, 2013

(30) Foreign Application Priority Data
Apr. 28, 2011 (IT) RM2011A000223

(51) Int. Cl. B01J 19/00

(52) U.S. Cl. CPC B01J 19/00
USPC 422/513

(57) ABSTRACT

Device for the synthesis of peptide-based radioactive drugs, for diagnostic and/or therapeutic use, includes: a frame; a closing case for the frame; a first disposable main module; a second disposable module, slidingly associated with the first module; a third disposable test-tube holder module, reversibly fixable to the frame (100) with fixing elements that allow the translation thereof with respect to the same. The first, second and third modules are arranged for irreversibly coupling so as to form one single disposable collector inside which the whole synthesis process of the concerned radioactive drug is performed, where at the end of the process, the collector may be removed from the device as one single contaminated mono block. The device is controlled by a remote control and drive workstation that includes a computer and devices for storing and managing data concerning the synthesis of the specific radioactive drug obtained for each treated patient.

The present invention concerns the field of laboratory devices used for the synthesis of radioactive drugs.

More in detail, it concerns an automatic device for the synthesis of peptide-based radioactive drugs for diagnostic and/or therapeutic use.

As it is known, the radiometabolic therapy, or TRT (Targeted Radiation Therapy), is a non-invasive therapeutic treatment that allows to selectively irradiate specific tissue targets, by using biomolecules labelled with radioisotopes.

Said therapy grounds its effectiveness on the selective captation of the radioactive drug by tumor cells, with a minimal retention of the same in blood and in healthy organs, and further has the advantage of allowing live monitoring—before and during therapy—of said drug distribution in the patient's body.

As it is known, many peptides, together with the relative receptor systems, have been studied, both in vitro and in vivo, for the purpose of allowing the use thereof as radiolabelled tracers for the diagnostic and/or therapeutic treatment of solid tumours.

Furthermore, it is known that for the peptides to be used as radioactive drugs, they must be functionalized with special chelating substances able to complex the radionuclides thus allowing the incorporation thereof in the molecular structure of the same. The chelating agents are chosen according to the particular features of the specific radioisotope used, like e.g. the dimension and the coordination geometry.

In the development of radiopharmaceuticals of peptidic nature, metallic radioisotopes are largely used (like e.g. 99 mTc, 111In, 68Ga, 90Y and Lu177) due to their particular nuclear properties (half-life, kind of radiation, gamma rays and beta particles emitters) and for their rich coordination chemistry.

Usually, the synthesis of a peptide-based radioactive drug, for diagnostic and/or therapeutic use, is divided in the following phases:
a selection step of an appropriate buffer containing the chelating substance (of gentisic, ascorbic, acetate kind etc.), with which the peptide is to be mixed up at appropriate concentrations;
a step for mixing the radionuclide with said buffered peptide mixture;
a warming-up step, whereby the duration and the performing temperature may vary according to the nature of the used peptide and chelating substance;
a purification step, performed by means of chromatographic techniques;
a step of sterilization, and of quality controls. of the obtained radioactive drug.

Said proceeding is done manually in hospital, starting from a solution containing the radioisotope concerned.

The whole procedure requires the highest chemical purity of the starting materials, most of all of the radioisotope that might be contaminated, during the different production and/or working steps, with small amounts of heavy metals (e.g. Fe, Cu, Pb) which are able to interfere with the labelling of the peptides.

For forming the radionuclide-chelator-peptide complex, it is necessary to warm up the mixture of said elements at about 100° C. for some minutes, as the kinetics of incorporation of the metal into the chelator is notoriously slow; furthermore, for said complex to be stable, the reaction pH must be kept at optimal levels (near to five), as at too high pH said elements form insoluble hydroxides, escaping the reaction, while at too acid pH values the chelator would not work properly.

The formation step of the radionuclide-chelator-peptide complex requires optimal reaction conditions, aimed at obtaining a product with the highest possible radiochemical purity, since, even a small percentage of free radioisotope, if not properly complexed in the form that can be eliminated by the body, represents a serious risk to the patient.

Moreover, said step requires the up-keeping of a high specific labelling activity; since, in consideration of the low number of radioactive atoms with respect to the number of molecules to be labelled, there is always a large majority of not labeled chemical species competing for the formation of the binding site with the radionuclide-chelator-peptide elements.

At the end of the process, the quality control of radiochemical purity of the obtained radiopharmaceutical is performed by means of analysis tools like Radio HPLC and Radio TLC, or else by means of inversed phase chromatographic separation process, with the purpose of evaluating the incorporation percentage of the radionuclide inside the chelator, and the possible formation of undesired by products.

At last, at the end of identification of the chemical species formed, easier quality controls are performed, or quality controls with purification phases which may replace above mentioned quality controls if appropriately validated.

As radioactive drugs must satisfy the requirements of injectability, each of above mentioned steps of synthesis must be performed in such a way as to assure sterility and apyrogenicity of the obtained radioactive drug and, more in general, to be in agreement with the Standards of Good Preparation of Radiopharmaceuticals.

In consideration of the complexity of above described process, it appears evident that a minimum error of the radiochemist, in any of the steps forming the same, may invalidate the result of the synthesis process, and consequently cause the qualitative decay of the obtained radioactive drug, which in any case will be characterized by a minimal fluctuation of the yield of labelling depending on the manuality of the single operator.

The use in said process of substances able to emit ionizing radiations furthermore implies a sanitary risk for the operators and for the environment, against which it is necessary to provide adequate security protocols for assuring the minimal exposure of the staff to the harmful effects of said substances as well as the minimum dispersion in the surrounding, according to the ICRP (International Commission on Radiological Protection) Recommendations, assimilated in the Italian Law with legislative decree 230/95.

Automated devices for the preparation of peptide-based radioactive drugs are already known, for the radiometabolic treatment of solid tumors.

A first automated device for the synthesis of peptide-based radioactive drugs is realized by the firm “Comecer”, and it consists of fifteen valves with a dead volume equal to zero, serially connected so as to form one kit for single use only. The rotating parts of the valves are directly engaged on the mechanics of the device, in correspondence with the respective motor. Furthermore, two precision actuators are provided for handling two process syringes, of different volume, and five radioactivity detectors. Said device allows to repeat the synthesis procedure of the radioactive drug, but does not allow the sterilizing filtering of the radioactive drug directly in the vial to be used for administration, nor to have a phial of a drug with partial activity.

Said device has no kind of shielding, has no stopping system in case of failure, nor means allowing its connection to a 68Ga generator, for use in diagnostic field.

A second automated device for the synthesis of peptide-based radioactive drugs is realized by the firm “Eckert&Ziegler” and comprises a heating system, provided with a temperature control in the solid state from −40° C. to 150° C.-220° C., pressure and radiation detectors. Said device has the disadvantage that its components require washing at the end of each utilization cycle.

Said firm “Eckert&Ziegler” produces a further automated device for the synthesis of peptide-based radioactive drugs, provided with sterile boxes for single use only, which do not need washing cycles. The use of said device is extended to the clinical production of different types of radio-peptides.

US2006/0245980A1 discloses an automated device for the synthesis of radioactive drugs, comprising at least one kit for single use for containing reagents, valves and containers for mixing the reagents, means for keeping said valves and containers, fluidic flexible ducts for connecting said valves and containers to said disposable kit so that, at the end of the process of synthesis of the radioactive drug concerned, said disposable kit may fall into a dedicated disposal container, where it may be collected, without any manual intervention.

Said device has the disadvantage of performing the process of synthesis of the radioactive drug concerned inside the structural frame of the device, and not in the disposable kit, thus requiring washing and cleaning of all contaminated components at the end of each utilization cycle. Moreover, the operator can not come into contact with the disposable kit because the latter is not able to shield all radioactive components inside the same.

WO2010/021719A1 discloses an automated device for the synthesis of radioactive drugs, comprising a reaction container with a sealing cap which communicates with a plurality of fluidic ducts. Said fluidic ducts are arranged for entering into said vessel the reagents and process gases needed for the synthesis of the radioactive drug concerned, and they are also arranged for creating a vacuum functional to its emptying, at the end of the synthesis process of said radioactive drug. The device may be remote controlled and has a modular structure into which additional components may be integrated like modules for containing and transferring the reagents, modules for the purification of the compounds, reaction modules, radioactivity meters, and other.

Said device has the disadvantage that it performs the synthesis process of the radioactive drug concerned inside its own constitutive structure, and that it does not use any disposable kit for the performance of said process. WO2008/091694A discloses an automated device for the synthesis of radioactive drugs, in particular for the synthesis of radioactive markers for PET (Positron Emitting Tomography), comprising a synthesis chip, a source of reaction, a process controller, a reaction chamber, at least one inflow duct of the reagents, at least one control valve connected to said duct. Furthermore, the device may be provided with means for warming and/or cooling down reagents as well as with shielding arranged for protecting the operators from the radiations emitted by said substances.

Said device as well has the disadvantage that it performs the synthesis process of the radioactive drug concerned inside itself, and does not use any disposable kit for containing the reagents necessary to the performance of said synthesis process.

US1994/5312592A discloses an automated device for the synthesis of radioactive drugs comprising a shielded reaction chamber and a loading device for said reaction chamber, onto which a disposable kit containing only the reagents is assembled. Furthermore, the device comprises a first actuator, arranged for moving the loading device from a resting position, outside the reaction chamber, to a working position, inside said chamber, and a second actuator, arranged for determining—at the end of the process for the synthesis of the radioactive drug concerned—the detachment of the used disposable kit from the loading device, so as to make said kit fall inside the lower section of the reaction chamber, acting as a collection container.

Above mentioned device has the disadvantages that they perform the synthesis process of the radioactive drug concerned inside a fixed reaction chamber, and they require the manual disposal of the kits containing the reagents, exhausted during the synthesis of above mentioned radioactive drug, without any protection for the operators.

It is the aim of the present invention to overcome the problems inherent in the synthesis of peptide-based radioactive drugs.

It is a further aim of the present invention to overcome the defects and limitations of existing automatic devices, used for the synthesis of said radioactive drugs.

It is therefore aim of the present invention to realize an automatic device that, controlled by a remote control workstation, allows the synthesis of peptide-based radioactive drugs for diagnostic and/or therapeutic use, inside a disposable block comprising modules appropriately shielded and tightly connected between each other so as to form one single mono block collector containing therein all components that get usually contaminated during the synthesis process, comprising containers, needles and fluidic ducts for the connection between the different sections and of the gases, thus overcoming the inherent practical difficulties of the manual preparation of the same and at the same time saving the operator from the prolonged and close exposure to radioactive products.

The aim set forth is reached by an automatic device for the synthesis of peptide-based radioactive drugs for diagnostic and/or therapeutic use, comprising:
a structure frame;
a possible closing case for said structure frame;
a remote control and drive workstation, arranged for allowing the total management of the device,
   characterized in that it comprises:
a first disposable main module;
a second disposable module, slidingly associated with said first main module;
a third disposable test-tube holder module, reversibly fixable to said structure frame with fixing means that allow the translation thereof with respect to the same structure frame,
   wherein said structure frame comprises:
a plurality of injectors slidingly bound to said structure frame, arranged for introducing an inert process gas into said first main module, into said sliding module and into the test-tube holder module connected thereto;
means for warming up said test-tubes, slidingly associated with said structure frame, and that may be selectively operated and associated with said third test-tube holder module;
a movable support, slidingly associated to said structure frame, carrying a radioactivity meter and a phial for collecting the radioactive drug obtained;
a plurality of actuators, slidingly associated to said structure frame, arranged for moving the above listed components;
   and wherein said first, second and third module are arranged for irreversibly coupling so as to form one single disposable collector, inside which the whole process of synthesis of the radioactive drug concerned is performed, whereby, at the end of the cycle, said collector is removable from said device, as one single contaminated mono block element.

Further features of the device according to the present invention are described in the dependent claims.

The device according to the present invention has the following advantages, allowing:
to remove from the device and to dispose with one single operation all components and all connection paths that came into contact with the substances used for the preparations of the radioactive drug, due to the fact that they all belong to the disposable modules which appear, at the end of the cycle, tightly and irreversibly assembled to one another so as to form one single contaminated mono block element;
to improve quality and constancy of the obtained radioactive drug, by overcoming the inherent practical difficulties of the manual execution of the relative synthesis process, thus ensuring a precise repeatable and reliable labelling of the peptides which—being guaranteed by the electronic monitoring of the different steps of the process and by the sequential monitoring of each operative step—does not depend on the characteristics of the single operators and does not need later corrections;
to reduce the risk of the operator being exposed to ionizing radiations, by performing a synthesis process completely inside disposable blocks appropriately shielded and tightly connected to one another, workstation placed at a security distance from the synthesis device;
to increase the number of daily peptide labellings, thus allowing to increase the number of patients treated and of testing of new radio peptides, without suffering the problems connected to excessive operator's exposure to ionizing radiations, to the prolonged times of completion of the finished radioactive drug, and of the waiting time of the natural decay of the radionuclide used, prior to being able to perform a new process of synthesis;
to realize a standard synthesis protocol that allows the constant monitoring of the whole synthesis process and that consequently guarantees the safety of the obtained radioactive drug given to the patient;
an extremely precise calibration of the dosage of the radioactive drug to be given to the patient, by using a dedicated radioactivity meter, thus allowing to obtain a vial of finished radioactive drug characterized by the partial activity requested for the specific patient treated;
to avoid oxidation of preparation reagents, used in the synthesis of the radioactive drug concerned, by making use of a special inert gas during the different taking and transfer of said substances, like e.g. nitrogen;
to use the device in laboratories of any dimensions, due to the small dimensions of the same;
to improve the organization, in terms of electronic storage, of the whole paper records produced until now.

Further features and advantages of the device according to the present invention shall appear more clearly from the following description of a preferred embodiment, made by way of an indicative and non-limiting example, with the help of figures.

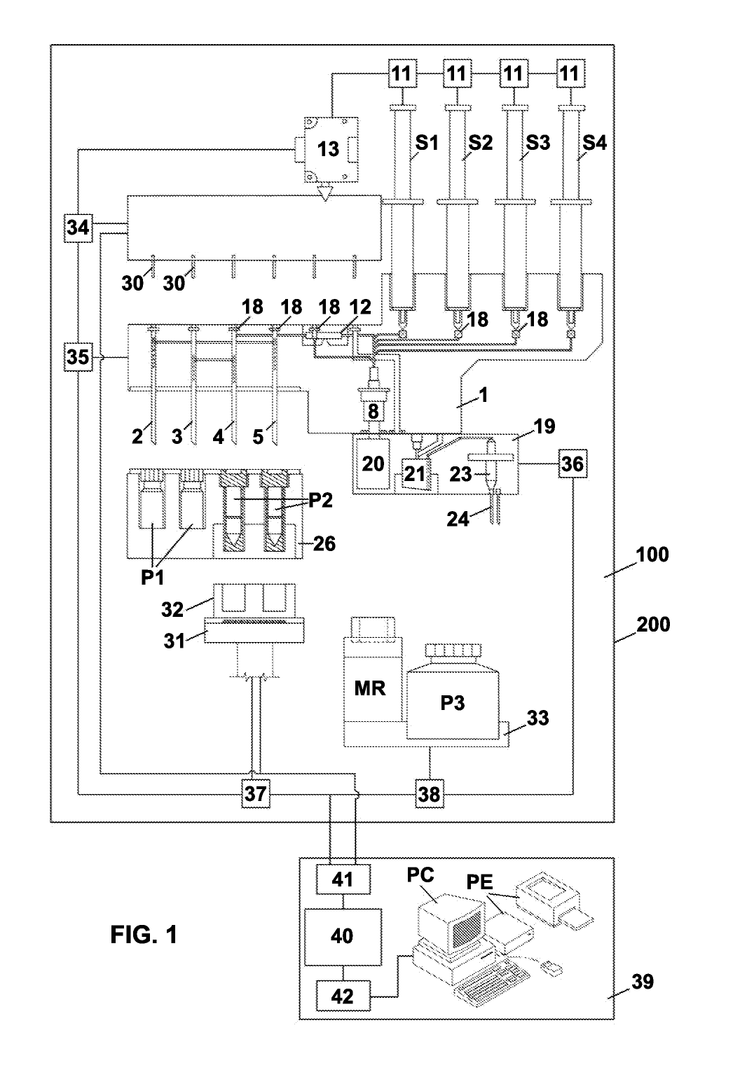

FIG. 1 shows a block scheme of the structural conformation of an automatic device for the synthesis of radio peptides for diagnostic and/or therapeutic use, according to the present invention.

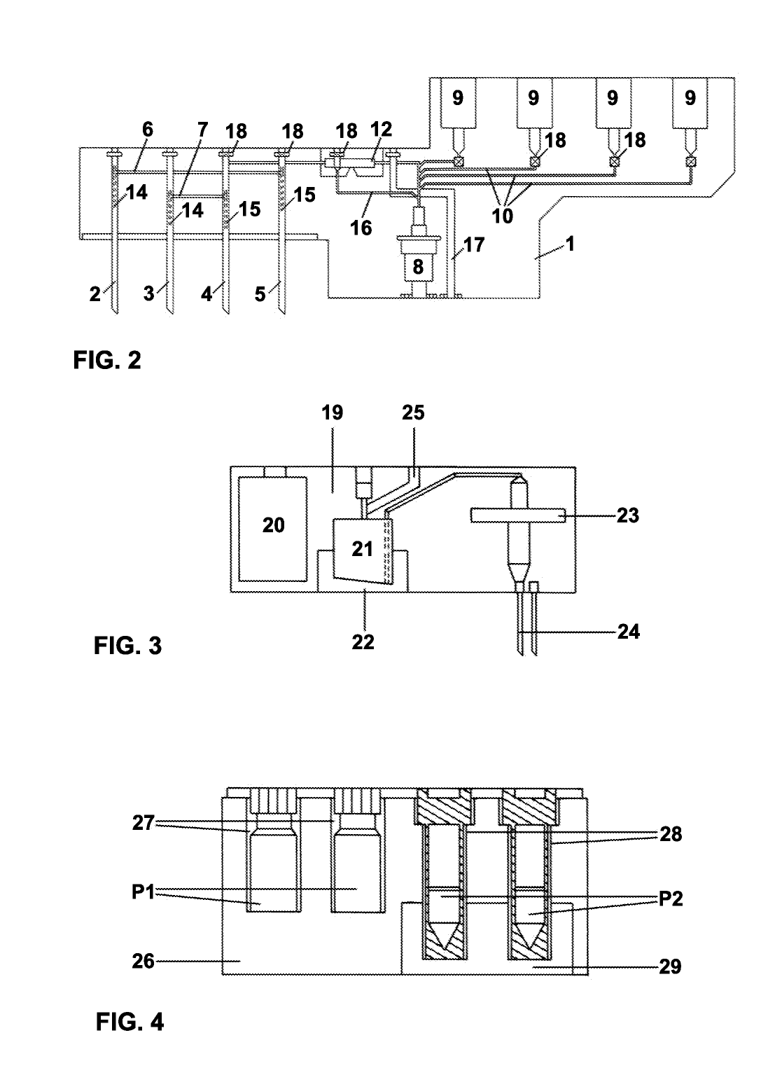

FIGS. 2-4 respectively show a longitudinal section of the structural conformation of the main module, of the module sliding on the main module and of the test-tube holding module, forming the disposable collector used by said synthesis device.

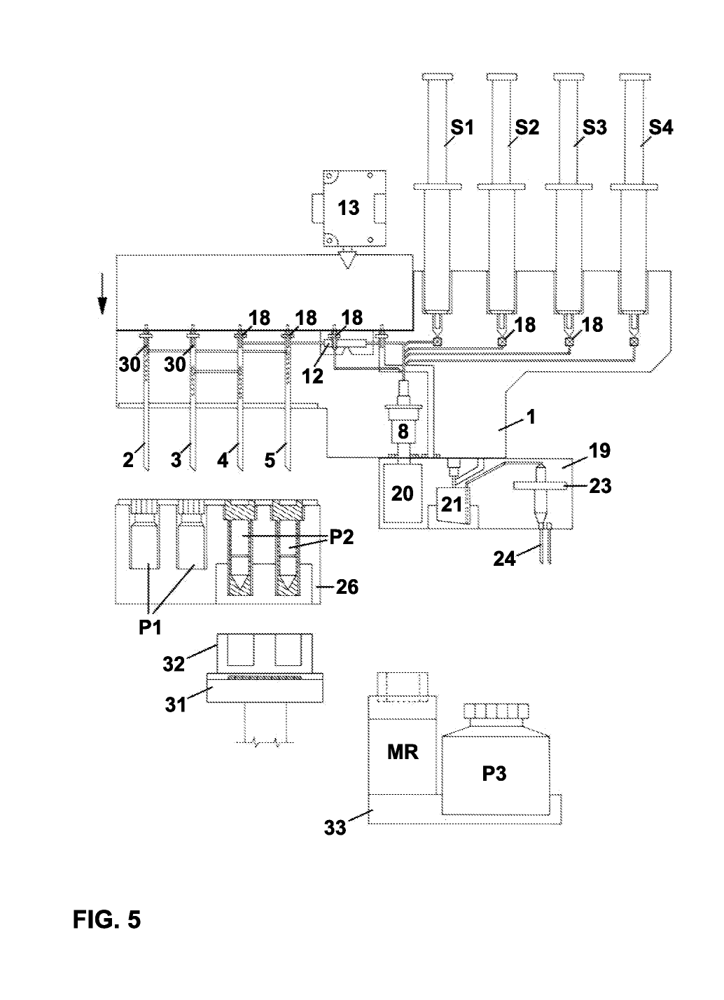

Following FIGS. 5-10 show components of said synthesis device during the different steps of the synthesis of a peptide-based radioactive drug.

Relating to the details of FIGS. 1, 2, 3 and 4, the automatic device for the synthesis of radio peptides for diagnostic and/or therapeutic use according to the present invention, mainly consists of:
a structure frame 100;
a possible closing case 200, for said structure frame;
a main module 1, of the sterile and disposable type, out of polymethyl methacrylate and having a thickness suitable to ensure the shielding of the operator from the ionizing radiations emitted by the used radioisotopes, inside which can be found:
   needles 2, 3, 4, 5 for taking and transferring, with a calibrated internal hole, wherein the needles 4, 5 are made out of non-metallic materials so as to prevent possible interferences with the ongoing chemical reactions, and wherein needles 2, 3 respectively communicate with said needles 5, 4 through fluidic ducts 6, 7;
   a cartridge C18 primary filter 8, consisting of a chromatographic column able to hold the labelled peptide needed for the synthesis of the radioactive drug and not the free peptide, thus also performing the function of purification of the same;
   housings 9 arranged for containing process syringes S1, S2, S3, S4 containing the preparation reagents needed for the synthesis of the concerned radioactive drug, communicating through a hydraulic circuit 10, provided with micro non-return valves 18, with said primary filter 8 and driven by pneumatic actuators 11 with electromagnetic stops, arranged for allowing selective operation thereof;
   a flexible duct 12, communicating with transfer needles 4, 5 and with said primary filter 8, the reversible occlusion thereof—made possible by a micro-piston with variable stroke 13—allows to separate the preparation phase of the concerned radioactive drug from the purifying phase thereof;
   pneumatic ducts 14, 15, 16, 17, wherein the ducts 15, 16 are provided with non-return micro valves 18, arranged for the introduction of process nitrogen into the various components of said main module 1 and of the sliding module 19 connected thereto;
a sliding module 19, of the sterile and disposable type, out of polymethyl methacrylate and of a thickness suitable to ensure the shielding of the operator from the ionizing radiations emitted by the used radioisotopes, connected to said main module 1 and fixed in such a way as to slide in the same, and inside which the following elements are provided:
   a chamber for collecting the wastes 20;
   a chamber 21 for collecting the radioactive drug obtained, provided with a housing 22 for receiving the reading head of a radioactivity meter MR;
   a 0.22 μm antibacterial final filter (23) for the preparation;
   needles 24 arranged for transferring the radioactive drug obtained into an appropriate physiological solution, associated with said final filter (23);
   a pneumatic duct 25 arranged for introducing process nitrogen into the collection chamber 21 of the radioactive drug obtained.
a test-tube holder module (26), of the sterile and disposable type, out of polymethyl methacrylate and of a thickness suitable to ensure the shielding of the operator from the ionizing radiations emitted by the used radioisotopes, in which the following elements are provided:
   housings 27 for containing test-tubes P1 containing the radionuclide chosen for the synthesis of the concerned radioactive drug;
   housings 28 arranged for containing test-tubes P2 containing the peptides buffered with the chelating specific for said radionuclide;
   a housing 29 arranged for inserting of a special warming up thermoblock (31) into the structure of said test-tube holder module 26, in correspondence with said test-tubes P2;
a plurality of injectors 30 slidingly fixed to said structure frame 100 and controlled by suitable (not shown) solenoid valves, arranged for the introduction of an inert process gas into main module 1 and, at the same time, into the sliding module 19 and into the test-tube holder module 26 when connected to said main module 1;
a thermoblock 31, slidingly associated to structure frame 100, provided with suitable insulation means 32 and controlled by a time relay/circuit with a condenser discharge, provided with a vertical sliding movement and arranged for being inserted into housing 29 of the test-tube holder module 26 so as to determine the warming up of the radionuclide-chelator-peptide mixture formed inside test-tubes P2, where the warming up time and temperature may be set according to the synthesis details of the used radio-nuclides, preferably for a time period of about 30 minutes and at a temperature of about 100° C.;
a movable support 33, slidingly associated to the structure frame 100, comprising a radioactivity meter MR and a phial P3 containing the physiologic solution into which the obtained radioactive drug will be transferred;
an actuator 34, of the double effect type, slidingly associated to the structure frame 100, arranged for moving said injectors 30 and, at the same time, the main module 1, after the connection of the same with the pneumatic ducts 14, 15, 16, 17 of said main module (1);
an actuator 35, of the pneumatic type, slidingly associated to the structure frame 100, arranged for restoring the initial position of the main module 1 at the end of the synthesis cycle of the concerned radioactive drug;
an actuator 36, of the rotating and/or linear arm type slidingly associated to the structure frame 100, arranged for moving the sliding module 16 on the main module 1;
actuators 37, 38, of the simple effect piston type with a spring return, slidingly associated to the structure frame 100, respectively arranged for moving the thermoblock 31 and the movable support 33;
a remote control and drive workstation 39, arranged for allowing the complete management of the synthesis device, that comprises:
   a control unit 40, of the PLC (Programmable Logic Controller) type, arranged for coordinately managing the working of the above listed components;
   connection interfaces 41 for the interconnection of said control unit 40 with said components of the synthesis device;
   a connection interface 42 for the interconnection of said control unit 40 with a personal computer PC through which the operator may interact, at safety distance, with the whole synthesis process;
   devices PE for storing and managing the data concerning the synthesis of the concerned radioactive drug obtained for each single treated patient, interconnected by means of standard interfaces known to said personal computer PC.

The main module 1, the sliding module 19 and the test-tube holder module 26 are arranged for mechanically and irreversibly coupling so as to form, during the functioning of above described device, a disposable collector 300 inside which all components that may be contaminated during the process are placed, and inside which the whole synthesis process of the concerned radioactive drug takes place.

Said collector 300 is arranged for being removable, at the end of the synthesis process, as one single mono block element of above described device, and disposed in complete safety by means of special approved containers.

The main module 1, the sliding module 19 and the test-tube holder module 26, forming said disposable collector 300, consist of symmetric pairs of blocks, the adjacent faces thereof being shaped and reciprocally assembled so as to form monolithic structures arranged for comprising both the housings of the components involved in the synthesis process of the concerned radioactive drug, and the transit conduits for fluids and gases used for said synthesis process.

The main module 1, the sliding module 19 and the test-tube holder module 26, moreover, are realized out of building materials (e.g. polymethyl methacrylate), and structural thicknesses arranged for ensuring the complete shielding of the components and of the ducts involved in the synthesis process of the concerned radioactive drug, and consequently the complete protection of the operator from the ionizing radiations usually emitted by the radioisotopes used for said synthesis process.

According to the present invention, the operator assigned to the apparatus—with the synthesis appliance open—performs the following preliminary operations:
he inserts test-tubes P1-P2 respectively containing the radioisotope and the buffered peptide, into the special housings 27, 28 of the test-tube holder module 26;
he fills up the process syringes S1, S2, S3, S4 with the appropriate solutions;
he takes from the special sterile packaging the main module 1, to which the relative sliding module 19 is pre-assembled, and then he inserts said process syringes S1, S2, S3, S4 into the special housings provided on the same.

Said process syringes S1, S2, S3, S4 contain, in order:
ethanol, used for the activation of the primary filter 8 of the main module 1, and for eluting the labelled peptide bound to the resin forming said filter, so as to allow the taking thereof;
DTPA (Diethylene triamine pentaacetic acid), used for washing said primary filter 8, and for removing possible traces of free radioisotope from the same;
water, used for washing said primary filter 8;
saline solution for strengthening the action of ethanol.

Now the operator will start the cycle of synthesis by starting the remote control and drive workstation 39, the control unit 40 thereof—after having performed a preliminary diagnostic test arranged for verifying the complete functionality of the appliance—will request the operator of:
inserting the physiological solution phial P3;
inserting the test-tube holder module 26;
inserting the main module 1.

Following the instructions received, the operator will now:
insert the physiological solution phial P3 onto the special mobile support 33;
insert the test-tube holder module 26 into the synthesis device;
insert the main module 1 pre-assembled on the relative sliding module 19 into the synthesis device.

Now the operator gets back to the remote control and drive workstation 39, placed in a safe area, and once he has verified the correct insertion of above listed elements, he will perform the identification procedure patient/radioactive drug and then gives the command for starting, as a consequence, the effective operating sequence.

Consequently, the control unit 40 performs the following operations:
it performs an auto-test (“STATUS checklist”), and if all operative conditions are fulfilled it starts the synthesis process of the radioactive drug, recording all data asked by the operator, like e.g. the starting time of the procedure, the code of the receiver of the compound and other information;
it starts the warming up of thermoblock 31, which means that the same reaches and maintains a preferred temperature of about 100° C. for a preferred time of about 30 minutes, wherein said warming up time and temperature may be set according to the synthesis features of the radio-nuclides used;
it enables the next step (“ENABLE NEXT”).

The pneumatic actuator 34 receives from said control unit 40 the drive that allows injectors 30, connected to (not shown) process solenoid valves, to lower and to get inserted into pneumatic ducts 14, 15, 16, 17 of main module 1, as shown in FIG. 5.

Once the coupling between injectors 30 and main module 1 is done, the control unit 40 takes the signal of command executed (“DONE”) and enables the next step.

The pneumatic actuators 34, 35 of the whole composite module formed in the precedent step, receive from the control unit 40 the command (“DOWN TO RR”) that enables said composed module to insert on the test-tube holder module (26) (“Reagents Rack”) under controlled speed, allowing needles 2, 3 integral with main module 1, to perforate the caps of test-tubes P1, and to needles 4, 5 integral with said main module 1 to get inserted into test-tubes P2, thus allowing the mechanical coupling between said main module 1 and the test-tube holder module 26, thus forming a disposable collector 300, inside which the whole synthesis process of the concerned radioactive drug will be performed.

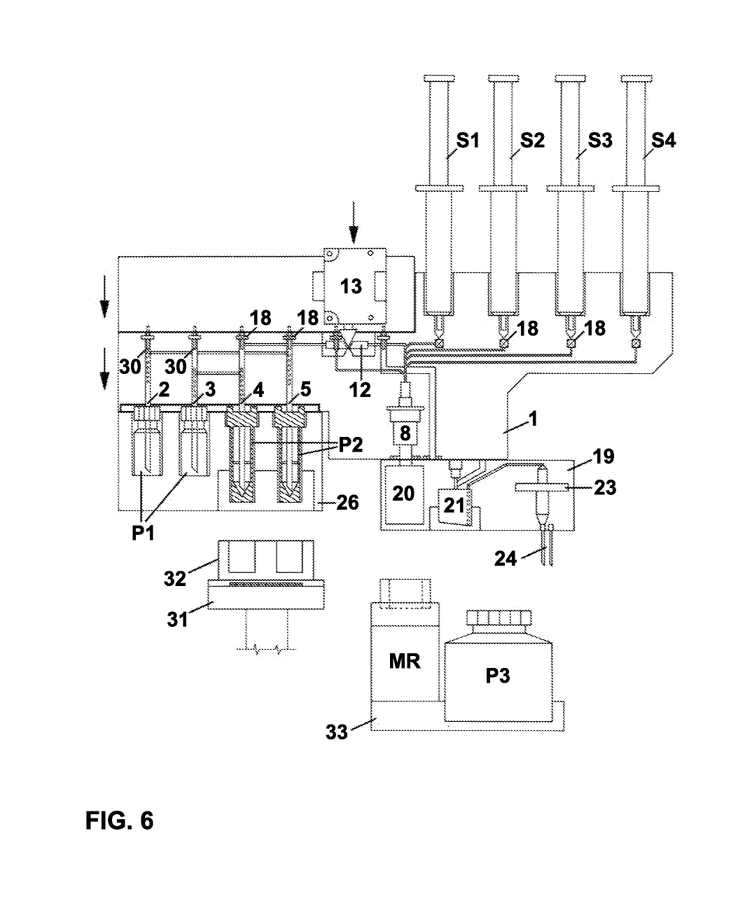

During said step, the variable stroke micro-piston 13 is operated, allowing the reversible occlusion of flexible duct 12, as shown in FIG. 6.

The control unit 40 detects the “done” signal (“DONE”) enabling the following step (“ENABLE NEXT”) which consists in the conditioning step of the primary filter 8 of main module 1, which is aimed at the washing of the same with water and ethanol, wetting the resin forming the same, and at the same time removing possible impurities.

Consequently, actuator 11 corresponding to process syringe S1 gets operated by control unit 40, thus powering said syringe, and enabling the passage of ethanol contained therein into the primary filter 8 of the main module 1 and subsequently into the waste chamber 20 of the sliding module 19 coupled to the same, by means of the special hydraulic circuit 10.

Then actuator 11 corresponding to process syringe S3 gets operated by control unit 40 thus powering said syringe and enabling the passage of the water contained therein into the primary filter 8 of the main module 1 and subsequently in the waste chamber 20 of the sliding module 19 coupled to the same, by means of the special hydraulic circuit 10.

The control unit 40 detects the “done” signal (“DONE”) and enables the next step.

The (not shown) solenoid valves, corresponding to injectors 30 associated to pneumatic ducts 14 of main module 1, receive from control unit 40 the opening command, thus determining the affluence of process nitrogen inside phials P1 in housings 27 of test-tube holder module 26, and consequently the passage of the radionuclide contained therein towards test-tubes P2 in housings 28 of said test-tube holder module 26, containing the buffered peptide, through fluidic ducts 6, 7 interposed between needles 2, 5 and 3, 4 of main module 1.

The control unit 40 detects the “done” signal (“DONE”) and enables the following step.

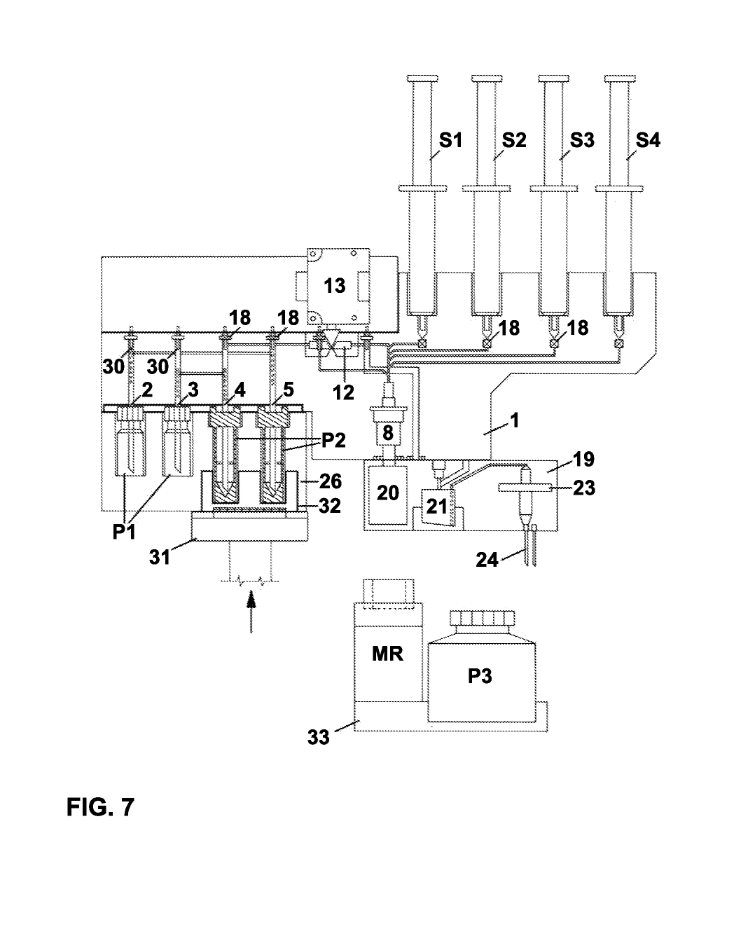

Actuator 37 associated to thermoblock 31, pre-heated at about 100° C., receives from control unit 40 the command allowing the same to rise and get inserted in the special housing 29 of the test-tube holder module 26, getting into contact with test-tubes P2 for about 30 minutes, as shown in FIG. 7.

In this period of time the micro-piston 13, acting as an on-off valve, will close deformable duct 12 integral with main module 1, thus obstructing the passage of the reagent products before the time requested for their warming up has expired.

Control unit 40 detects the “done” signal (“DONE”) and enables the following step (“ENABLE NEXT”).

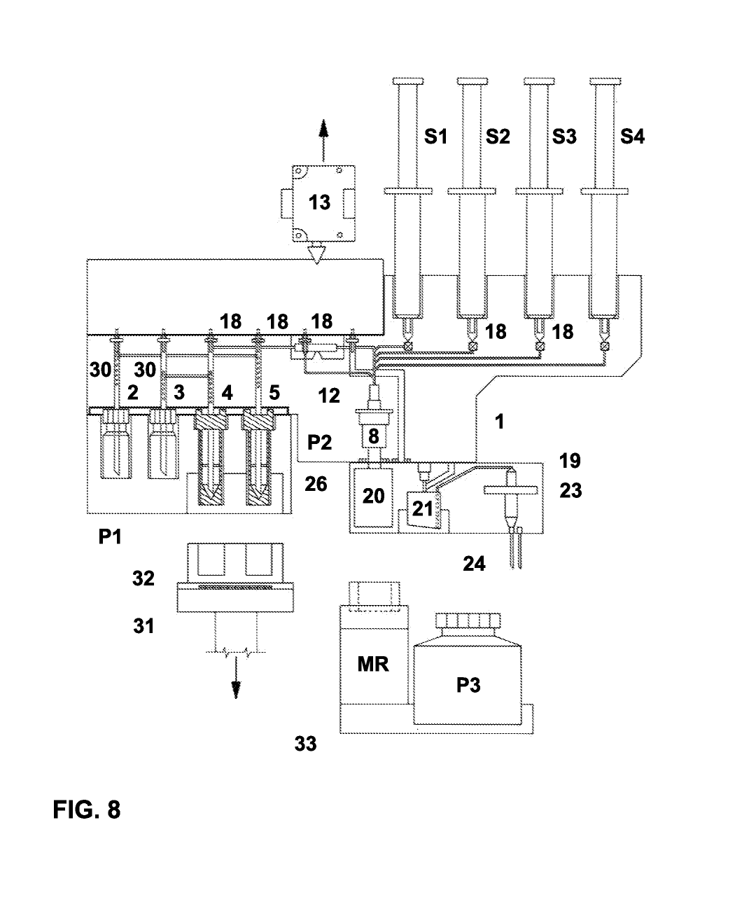

Actuator 37 associated to thermoblock 31 receives from said control unit 40 the command of lowering, while the (not shown) solenoid valves corresponding to injectors 30 associated to pneumatic ducts 15 of the main module 1 receive from said control unit 40 the opening command, thus determining the affluence of process nitrogen into test-tubes P2, containing the mixture of radioisotope and buffered peptide, and the transfer of the same—through flexible duct 12 and after opening the micro-piston 13—first into the primary filter 8 of the main module 1 and successively in the waste chamber 20 of the sliding module 19, as shown in FIG. 8.

Control unit 40 detects the “done” signal (“DONE”) enabling the following step (“ENABLE NEXT”), consisting in the purification step of the radioactive drug and having the purpose of removing possible traces of free radioisotope form the same.

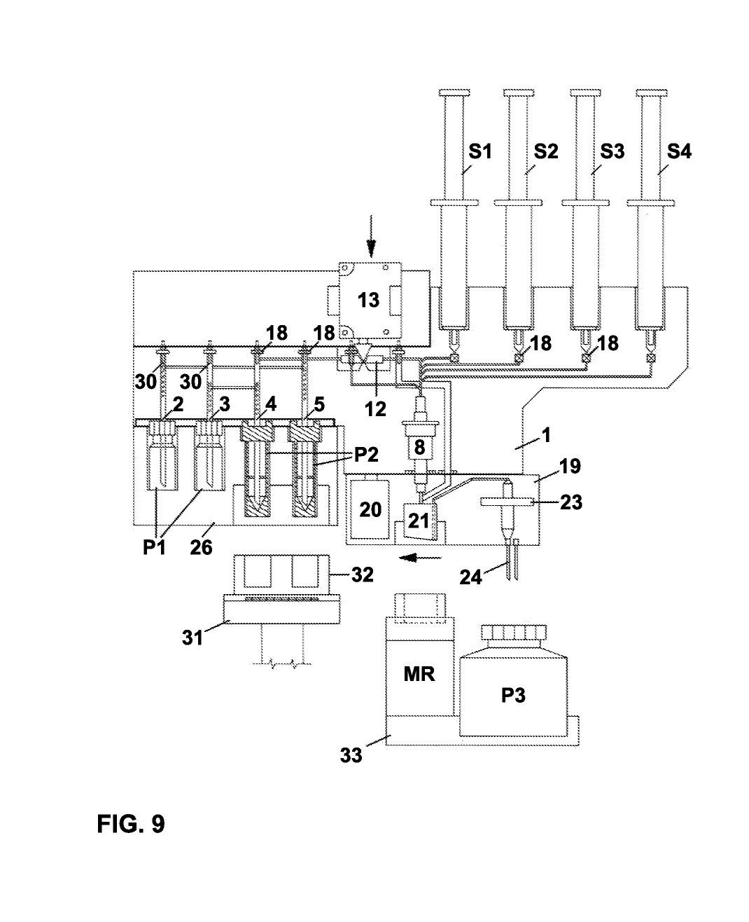

Actuator 11 corresponding to process syringe S2 receives from control unit 40—after closing micro-piston 13, as shown in FIG. 9—the command of operating said syringe, enabling the passage of DTPA contained therein into the primary filter 8 of the main module 1 and successively into the waste chamber 20 of sliding module 19 coupled to the same, by means of the special hydraulic circuit 10.

The control unit 40 detects the “done” signal (“DONE”) and enables the following step (“ENABLE NEXT”).

Actuator 11 corresponding to process syringe S3 receives from said control unit 40 the command of operating said syringe, allowing the passage of the water contained therein into the primary filter 8 of the main module 1 and successively into the waste chamber 20 of the sliding module 19 coupled to the same, by means of the special hydraulic circuit 10.

The control unit 40 detects the “done” signal (“DONE”) and enables the following step (“ENABLE NEXT”).

The (not shown) solenoid valve, corresponding to injector 30 associated to the pneumatic duct 16 of the main module 1 receives from said control unit 40 the opening command, determining the affluence of process nitrogen into the primary filter 8 of the main module 1 and successively in the waste chamber 20 of sliding module 19 coupled to the same.

The control unit 40 detects the “done” signal (“DONE”) and enables the following step (“ENABLE NEXT”).

Actuator 36 receives from said control unit 40 the command that determines the horizontal translation of sliding module 19 on the main module 1, allowing the respective communication of the primary filter 8 and the pneumatic duct 17 of said main module with collection chamber 21 and with the pneumatic duct 25 of said sliding module 19, as shown in FIG. 9.

The control unit 40 detects the “done” signal (“DONE”) and enables the following step (“ENABLE NEXT”).

Actuator 11 corresponding to process syringe S1 receives from control unit 40 the command of operating said syringe, thus allowing the passage of ethanol contained therein into the primary filter 8 of the main module 1 and successively into the collection chamber 21 in the sliding module 19 coupled to the same, by means of the hydraulic circuit 10.

The control unit 40 detects the “done” signal (“DONE”) and enables the following step (“ENABLE NEXT”).

The (not shown) solenoid valve corresponding to injector 30 associated to the pneumatic duct 16 of the main module 1 receives from control unit 40 the opening command, determining the affluence of process nitrogen into primary filter 8 of the main module 1 and successively into collection chamber 21 of the sliding module 19 coupled to the same.

The control unit 40 detects the “done” signal (“DONE”) and enables the following step (“ENABLE NEXT”).

Actuator 11 corresponding to process syringe S4 receives from said control unit 40 the command of operating said syringe, allowing the passage of the saline solution contained therein into the primary filter 8 of the main module 1 and successively in the collection chamber 21 of the sliding module 19 coupled to the same, by means of the special hydraulic circuit 10.

The control unit 40 detects the “done” signal (“DONE”) and enables the following step (“ENABLE NEXT”).

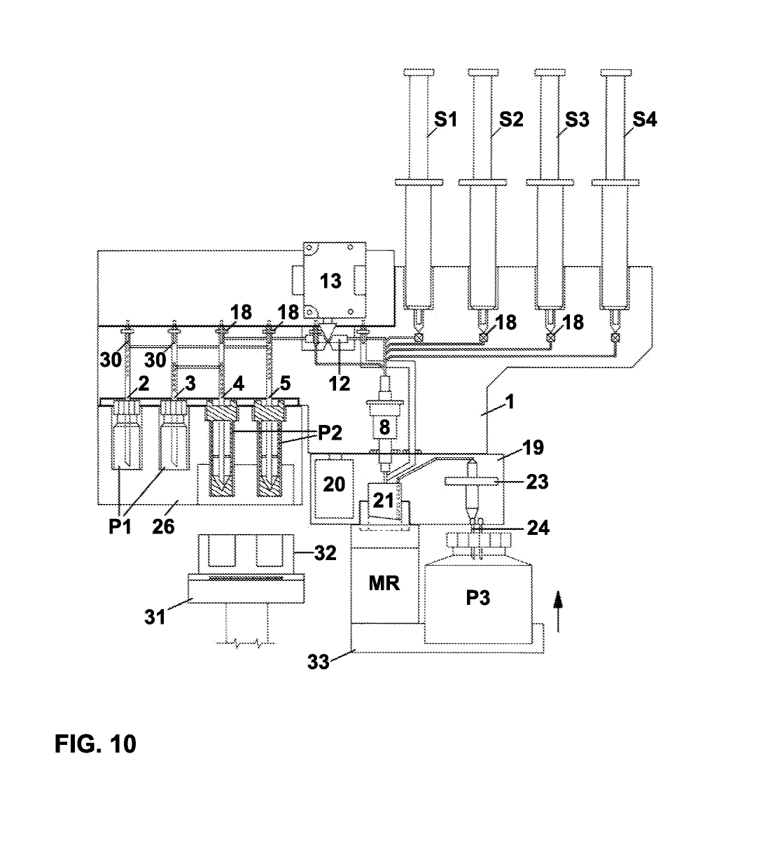

Actuator 38, associated to mobile support 33, receives from said control unit 40 the command that determines the rising of the same for determining the insertion of the radioactivity meter MR into the corresponding housing 22 of the sliding module 19, and the insertion of the transfer needles 24 of the radioactive drug into the physiological solution phial P3, as shown in FIG. 10.

The control unit 40 detects the “done” signal (“DONE”) and enables the following step (“ENABLE NEXT”).

The (not shown) solenoid valve corresponding to injector 30 associated to the pneumatic duct 17 of the main module 1 receives from said control unit 40 the command of opening, determining—through the pneumatic duct 25—the affluence of process nitrogen into the collection chamber 21 of the sliding module 19 containing the finished radioactive drug, and the passage of the same through a final antibacterial filter 23 and its following transfer, by means of needles 24 of said sliding modules 19, into test-tube P3 containing a physiological solution arranged for allowing the giving of the drug to the patient.

The control unit 40 detects the “done” signal (“DONE”) and enables the following step (“ENABLE NEXT”).

The operator may decide to end the phase of transferring the radioactive drug into the physiological solution according to the reading supplied by the radioactivity meter MR, expressed in mCurie, through a dialog box constantly active on the remote control and drive workstation 39 for the whole duration of the procedure.

Furthermore, through said dialog box, the operator may recover any excess of the finished radioactive drug from the collection chamber 21 of the sliding module 19.

The control unit 40 detects the “done” signal (“DONE”) and enables the following step (“ENABLE NEXT”).

Actuator 38, associated to the mobile support 33, receives from said control unit 40 the command that determines the lowering of the same, and consequently of the radioactivity meter MR and of the finished radioactive drug, contained in the vial P3 of physiological solution.

The control unit 40 detects the “done” signal (“DONE”) and enables the following step (“ENABLE NEXT”).

Actuator 34, determining the moving of injectors 30, receives from said control unit 40 the command that allows the same to get back to the starting position.

The control unit 40 detects the “done” signal (“DONE”) and performs the following actions:
it verifies the status of actuators 34, 35, 36, 37, 38 and of the different devices being part of the appliance;
it records the data relative to the synthesized radioactive drug, as well as the time when it is completed, by means of personal computer PC connected to the remote control and drive workstation 39 through special interface 42.

If all conditions are met, control unit 40 enables the following step (“ENABLE NEXT”).

Said control unit 40 now allows to recover phial P3, containing the finished radioactive drug, by lifting the possible closing case 200 of the appliance or by opening a possible small wing on the same, so as to allow the operator to easily take the final compound, without getting into direct contact with the same, and to place it into the deposit location external to said.

On inquiry by said control unit 40, the remote control and drive workstation 39 reports the operator
the end of the synthesis procedure of the radioactive drug;
the need of removing from the device the disposable collector 300 resulting from the reciprocal irreversible assembling of the main module 1, of the sliding module 19 and of the test-tube holder module 26.

Following to said readings, the operator performs the extraction of said disposable collector 300 and the subsequent disposal of the same in special approved containers.

The control unit 40 detects the “done” signal (“DONE”) and enables the following step (“ENABLE NEXT”), consisting in a diagnostic test of the device and in the subsequent preparation of the same to a new operative cycle.

Once it has been given to the patient, the obtained radioactive drug will prove to be able to bind itself to the tumor tissue according to the specific peptide used so as to allow the localization, or the selective removal thereof, by means of the special radioisotope incorporated therein.

1. An automatic device for the synthesis of peptide-based radioactive drugs, for diagnostic and/or therapeutic use, comprising:
a structure frame (100);
a possible closing case (200) for said structure frame (100);
a remote control and drive workstation (39), arranged for allowing the total management of the device,
characterized in that it comprises:
a first disposable main module (1);
a second disposable module (19), slidingly associated with said first main module;
a third disposable test-tube holder module (26), reversibly fixable to said structure frame (100) with fixing means that allow the translation thereof with respect to the same structure frame;
wherein said structure frame (100) comprises:
a plurality of injectors (30) slidingly bound to said structure frame (100), arranged for introducing an inert process gas into said first main module (1), into said sliding module (19) and into the test-tube holder module (26) connected thereto;
means (31) for warming up said test-tubes (P2), slidingly associated with said structure frame (100), and that may be selectively operated and associated with said third test-tube holder module (26);
a movable support (33), slidingly associated to said structure frame (100), carrying a radioactivity meter (MR) and a phial (P3) for collecting the radioactive drug obtained;
a plurality of actuators (34, 35, 36, 37, 38), slidingly associated to said structure frame (100), arranged for moving the above listed components;
and wherein said first (1), second (19) and third module (26) are arranged for irreversibly coupling so as to form one single disposable collector (300) inside which the whole process of synthesis of the radioactive drug concerned is performed, whereby, at the end of the cycle, said collector (300) is removable from said appliance, as one single contaminated mono block element.

2. A device according to claim 1, characterized in that the first main module (1) comprises:
needles (2, 3, 4, 5) for taking and transferring, with a calibrated internal hole, wherein the needles (4, 5) are made out of non-metallic materials so as to prevent possible interferences with the ongoing chemical reactions, and wherein the needles (2, 3) respectively communicate with said needles (5, 4) through fluidic ducts (6, 7);
a cartridge C18 primary filter (8);
housings (9) arranged for containing process syringes (S1, S2, S3, S4) containing the preparation reagents needed for the synthesis of the concerned radioactive drug, communicating through a hydraulic circuit (10), provided with micro non-return valves (18), with said primary filter (8) and driven by pneumatic actuators (11) with electromagnetic stops, arranged for allowing selective operation thereof;
a flexible duct (12), communicating with transfer needles (4, 5) and with said primary filter (8), the reversible occlusion thereof—made possible by a micro-piston with variable stroke (13)—allows to separate the preparation phase of the concerned radioactive drug from the purifying phase thereof;
pneumatic ducts (14, 15, 16, 17), wherein the ducts (15, 16) are provided with non-return micro valves (18), arranged for the introduction of an inert process gas into the various components of said main module (1).

3. A device according to claim 1, characterized in that the second module (19) comprises:
a chamber for collecting the wastes (20);
a chamber (21) for collecting the radioactive drug obtained, provided with a housing (22) for receiving the reading head of a radioactivity meter (MR);
an antibacterial final filter (23) for the preparation;
needles (24) arranged for transferring the radioactive drug obtained into an appropriate physiological solution, associated with said final filter (23);
a pneumatic duct (25) arranged for introducing an inert process gas into the collection chamber (21) of the radioactive drug obtained.

4. A device according to claim 1, characterized in that the third test-tube holder module (26) comprises:
housings (27) for containing test-tubes (P1) containing the radionuclide chosen for the synthesis of the concerned radioactive drug;
housings (28) arranged for containing test-tubes (P2) containing the peptides buffered with the chelating specific for said radionuclide;
a housing (29) arranged for inserting special warming up means (31) into the structure of said test-tube holder module (26), in correspondence with said test-tubes (P2).

5. A device according to claim 1, characterized in that it comprises a plurality of injectors (30), controlled by suitable solenoid valves, arranged for the introduction of an inert process gas into the main module (1) and, at the same time, into the sliding module (19) and into the test-tube holder module (26).

6. A device according to claim 1, characterized in that the warming up means (31) for said test-tubes (P2) comprise a thermoblock provided with suitable insulation means (32) and controlled by a time relay/circuit with a condenser discharge.

7. A device according to claim 1, characterized in that the actuators arranged for moving the movable elements of said device comprise:
an actuator (34), of the double effect type, slidingly associated to the structure frame (100), arranged for moving said injectors (30) and, at the same time, the main module (1), after the connection of the same with the pneumatic ducts (14, 15, 16, 17) of said main module (1);
an actuator (35), of the pneumatic type, slidingly associated to the structure frame (100), arranged for restoring the initial position of said main module (1) at the end of the synthesis cycle of the concerned radioactive drug;
an actuator (36), of the rotating and/or linear arm type, slidingly associated to the structure frame (100), arranged for moving the sliding module (16) on said main module (1);
actuators (37, 38), of the simple effect piston type with a spring return, slidingly associated to the structure frame (100), respectively arranged for moving the thermoblock (31) and the movable support (33).

8. A device according to claim 1, characterized in that the remote control and drive workstation (39) comprises:
a control unit (40), of the PLC (Programmable Logic Controller) type, arranged for coordinately managing the working of the above listed components;
connection interfaces (41) for the interconnection of said control unit (40) with said components of the device;
a connection interface (42) for the interconnection of said control unit (40) with a personal computer (PC) through which the operator may interact, at safety distance, with the whole synthesis process;
devices (PE) for storing and managing the data concerning the synthesis of the concerned radioactive drug obtained for each single treated patient, interconnected by means of standard interfaces known to said personal computer (PC).
